(19) United States
(12) Patent Application Publication
(10) Pub. No.: US 2022/0024459 A1
(43) Pub. Date: Jan. 27, 2022

(54) MOTION SICKNESS REDUCTION SYSTEM AND METHOD FOR VEHICLE OCCUPANTS

(71) Applicant: Hyundai Mobis Co., Ltd., Seoul (KR)

(72) Inventor: Ki Hee PARK, Gwacheon-Si (KR)

(73) Assignee: Hyundai Mobis Co., Ltd., Seoul (KR)

(21) Appl. No.: 17/381,293

(22) Filed: Jul. 21, 2021

(30) Foreign Application Priority Data
Jul. 21, 2020 (KR) 10-2020-0090603
Jul. 22, 2020 (KR) 10-2020-0091188

(51) Int. Cl. B60W 40/08; B60R 21/015

(52) U.S. Cl. CPC B60W 40/08; B60R 21/015; B60W 2040/0872; B60W 2540/22; B60W 2540/221; B60W 2040/0818

(57) ABSTRACT

A motion sickness reduction system for vehicle occupants, includes an information collector configured to collect driving information of a vehicle or state information of an occupant of the vehicle, a predictor configured to predict a motion sickness state of the occupant based on the driving information or the state information, and a driving display configured to display the driving information to the occupant for recognizing the motion sickness state.

### CROSS-REFERENCE TO RELATED APPLICATION

This application claims the benefit under 35 USC 119(a) of Korean Patent Application Nos. 10-2020-0090603 and 10-2020-0091188, filed on Jul. 21, 2020 and Jul. 22, 2021 in the Korean Intellectual Property Office, the entire disclosure of which is incorporated herein by reference for all purposes.

### BACKGROUND OF THE INVENTION

### 1. Field of the Invention

The present invention relates to a motion sickness reduction system and method for vehicle occupants.

### 2. Description of the Related Art

Motion sickness may occur when people are exposed to one or more specific motions for a long time. Here, factors such as temperature, smell, mood, and digestion may aggravate motion sickness.

Particularly, carsickness is experienced by many people, and thus various solutions to curb the same are proposed. A typical solution is a suspension that a person takes before riding in a car, but such a suspension has various side effects because it contains components such as scopolamine, dimenhydrinate, diphenhydramine, promethazine, and meclizine.

Accordingly, a patch-type motion sickness inhibitor has recently been mainly used. However, even the patch-type motion sickness inhibitor does not have the same effect for all people in all situations, and thus there are a lot of consumer complaints in terms of effects.

Motion sickness involving dizziness, nausea, and the like when riding in a car is caused by temporary confusion of the brain when there is discordance between inputs of sensory organs (vision, proprioceptors, the semicircular canals, etc.) that maintain balance or sense motion and posture.

People remember reactions of sensory organs such as eyes and ears to muscular motion in their brains, and when motion similar thereto occurs later, the sensory organs predict, prepare for and respond to the motion with remembered information. However, when a person is riding in a car, there is no muscular motion or a motion different from the existing memory appears, and thus sensory discordance occurs, resulting in motion sickness.

A conventional motion sickness sensing technique uses only extremely limited vibration information of vehicles and thus has a problem that a motion sickness state of an occupant cannot be accurately sensed.

It will be understood that the above matters described in the related art are merely for promotion of understanding of the background of the invention and should not be recognized as prior art well-known to those skilled in the art.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present invention provides a system for collecting driving information of a vehicle and biometric information of an occupant to predict motion sickness of the occupant and allowing the occupant to recognize the driving information to reduce the motion sickness, and a system for controlling a seat or a device provided in the seat and configured to notify the occupant of the driving information to reduce a motion sickness state of the occupant.

In one general aspect, a motion sickness reduction system for vehicle occupants, includes an information collector configured to collect driving information of a vehicle or state information of an occupant of the vehicle, a predictor configured to predict a motion sickness state of the occupant based on the driving information or the state information, and a driving display configured to display the driving information to the occupant for recognizing the motion sickness state.

The information collector may collect the state information through any one or any two or more of a camera configured to capture images of the occupant, a biometric sensor configured to sense biometric information of the occupant, and an indoor air sensor configured to sense indoor air of the vehicle.

The information collector may collect the driving information through either one or both of the vehicle's navigation system and a driving sensor provided outside of the vehicle to detect a state of a road surface the vehicle is traveling on.

The predictor may predict the motion sickness state by comparing the driving information with preset driving indexes and comparing the state information with preset state indexes.

The driving display may include a visual display configured to indicate the driving information inside the vehicle.

The visual display may allow the occupant to visually recognize the driving information through a display device, inside the vehicle, configured to display any one or any two or more of a speed of the vehicle, a driving direction of the vehicle, and an ambient light configured to indicate the speed or the driving direction of the vehicle.

The driving display may include a tactile display configured to tactually notify the occupant of a driving situation inside the vehicle.

The tactile display may allow the occupant to tactually recognize the driving information of the vehicle through an air vent of the vehicle and an ultrasonic haptic interface provided inside the vehicle.

The motion sickness reduction system may further include a controller configured to control vehicle indoor air when the predictor may predict motion sickness of a vehicle occupant.

The controller may be further configured to reduce motion sickness by operating any one or any two or more of a window, an air conditioner, an air cleaner, an oxygen generator, and an aroma generator of the vehicle to control the vehicle indoor air.

In another general aspect, a motion sickness reduction method for vehicle occupants, includes: an information collection operation of collecting driving information of a vehicle or state information of an occupant of the vehicle; a prediction operation of predicting a motion sickness state of the occupant based on the driving information or the state information; and a driving display operation of displaying the driving information to the occupant for recognizing the motion sickness state.

In the information collection operation, the state information may be collected through any one or any two or more of a camera configured to capture images of the occupant, a biometric sensor configured to sense biometric information of the occupant, and an indoor air sensor configured to sense indoor air of the vehicle.

In the information collection operation, the driving information may be collected through either one or both of the vehicle's navigation system and a driving sensor provided outside of the vehicle to detect a state of a road surface the vehicle is traveling on.

In the prediction operation, the motion sickness state may be predicted by comparing the driving information with preset driving indexes and comparing the state information with preset state indexes.

The driving display operation may include a visual display operation indicating the driving information inside the vehicle.

In the visual display operation, the occupant may be allowed to visually recognize the driving information of the vehicle through a display device inside the vehicle configured to display any one or any two or more of a speed of the vehicle, a driving direction of the vehicle, and an ambient light configured to indicate the speed or the driving direction of the vehicle.

The driving display operation may include a tactile display operation of allowing the occupant to tactually recognize the driving information of the vehicle inside the vehicle.

In the tactile display operation, the occupant may be allowed to tactually recognize the driving information of the vehicle through an air vent of the vehicle and an ultrasonic haptic interface provided inside the vehicle.

The motion sickness reduction method may further include a control operation of controlling vehicle indoor air when motion sickness of a vehicle occupant is predicted in the prediction operation.

In the control operation, motion sickness of the occupant may be reduced by operating any one or any two or more of a window, an air conditioner, an, air cleaner, an oxygen generator, and an aroma generator of the vehicle to control the vehicle indoor air.

In another general aspect, a motion sickness reduction system for vehicle occupants includes an information collector configured to collect driving information of a vehicle and motion sickness state information of an occupant, a predictor configured to predict a motion sickness state of the occupant through comparison with a preset value based on the information collected by the information collector, and a seat controller configured to control a seat on which the occupant sits such that the occupant recognizes the driving information of the vehicle based on the motion sickness state of the occupant predicted by the predictor.

The information collector may collect the state information of the occupant through any one or any two or more of a camera configured to capture images of the occupant, a biometric sensor configured to sense biometric information of the occupant, and an indoor air sensor configured to sense indoor air of the vehicle.

The information collector may collect the driving information through either one or both of the vehicle's navigation system and a driving sensor provided outside of the vehicle to detect a state of a road surface the vehicle is traveling on.

The predictor may predict the motion sickness state by comparing the driving information with preset driving indexes and comparing the state information with preset state indexes.

The seat controller may include a tactile display provided in seats of the vehicle and configured to allow the occupant to tactually recognize the driving information of the vehicle.

The tactile display may allow the occupant to tactually recognize the driving information of the vehicle through a cooling fan or a vibrating haptic interface provided in the seats of the vehicle.

The seat controller may further include a visual display provided in the seats of the vehicle and configured to allow the occupant to visually recognize the driving information of the vehicle.

The visual display may allow the occupant to visually recognize the driving information of the vehicle at any angle of the view of the occupant through a light provided in the seats of the vehicle.

The seat controller may further include an auditory display configured to allow the occupant to aurally recognize the driving information of the vehicle through a speaker provided in the seats or provided adjacent to the seats.

The seat controller may reduce motion sickness of the occupant by controlling air cells or a seat rotating device provided in seat cushions of the seats of the vehicle to change a sitting position of the occupant.

Other features and aspects will be apparent from the following detailed description, the drawings, and the claims.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram of a motion sickness reduction system for vehicle occupants according to an embodiment of the present invention;

FIG. 2 is a diagram illustrating a driving display of the motion sickness reduction system for vehicle occupants according to an embodiment of the present invention; and

FIG. 3 is a flowchart of a motion sickness reduction method for vehicle occupants according to an embodiment of the present invention.

FIG. 4 is a diagram illustrating a tactile display of the motion sickness reduction system for vehicle occupants according to an embodiment of the present invention;

FIG. 5 is a diagram illustrating a visual display of the motion sickness reduction system for vehicle occupants according to an embodiment of the present invention;

FIG. 6 is a diagram illustrating changing of sitting positions of a seat according to an auditory display and a driving display of the motion sickness reduction system for vehicle occupants according to an embodiment of the present invention.

### DETAILED DESCRIPTION OF THE PREFERRED EMBODIMENTS

Specific structural and functional descriptions of embodiments of the present invention disclosed in the present specification or application are illustrated for the purpose of describing embodiments according to the present invention, and embodiments according to the present invention may be implemented in various forms and should not be construed as being limited to the embodiments described in the present specification and application.

While embodiments according to the present invention are susceptible to various modifications and alternative forms, specific embodiments are shown by way of example in the drawings. However, the present invention should not be construed as limited to the embodiments set forth herein, but on the contrary, the present invention is to cover all modifications, equivalents, and alternatives falling within the spirit and scope of the present invention.

The terms “first” and/or “second” are used to describe various components, but such components are not limited by these terms. The terms are used to discriminate one component from another component. For example, a first component may be called a second component and the second component may be called the first component within the technical spirit of the present invention.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components. Further, other representations describing a relationship between components, that is, “between ˜”, “immediately between ˜”, “adjacent to ˜” and “directly adjacent to ˜” should be construed likewise.

The terms used in the specification of the present invention are merely used in order to describe particular embodiments, and are not intended to limit the scope of the present invention. An element described in the singular form is intended to include a plurality of elements unless the context clearly indicates otherwise. In the specification of the present invention, it will be further understood that the term “comprise” or “include” specifies the presence of a stated feature, figure, step, operation, component, part or a combination thereof, but does not preclude the presence or addition of one or more other features, figures, steps, operations, components, or combinations thereof.

All the terms that are technical, scientific or otherwise agree with the meanings as understood by a person skilled in the art unless defined to the contrary. Common terms as found in dictionaries should be interpreted in the context of the related technical writings not too ideally or impractically unless expressly disclosed herein.

Hereinafter, preferred embodiments of the present invention will be described in detail with reference to the attached drawings. Throughout the drawings, the same reference numeral represents the same member.

Therefore, the present invention has been made in view of the above problems, and it is an object of the present invention to provide a system for reducing motion sickness of an occupant by collecting driving information of a vehicle and biometric information of the occupant, predicting motion sickness of the occupant and causing the occupant to recognize the driving information.

An information collector 100, a predictor 200, a driving display 300, a visual display 310, a tactile display 320, and a controller 400 according to an illustrative embodiment of the present invention may be implemented through a nonvolatile memory (not illustrated) configured to store an algorithm configured to control operations of various components of a vehicle or data regarding software commands for reproducing the algorithm and a processor (not illustrated) configured to perform operation which will be described below using data stored in the memory. Here, the memory and the processor may be implemented as individual chips. Alternatively, the memory and the processor may be implemented as a single integrated chip. The processor may take the form of one or more processors.

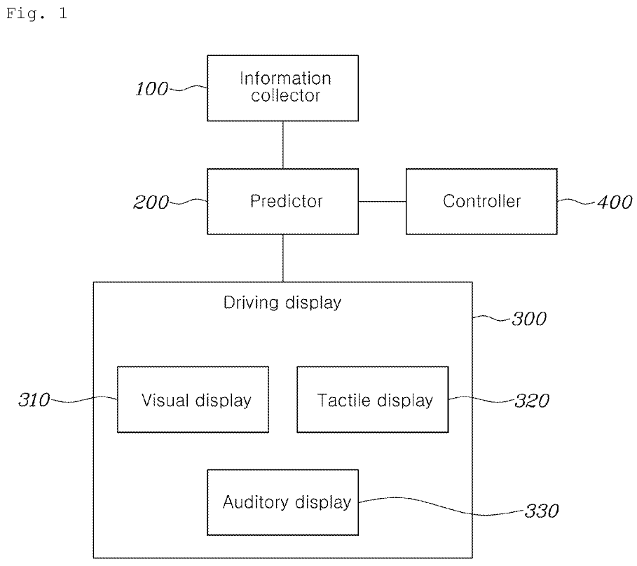

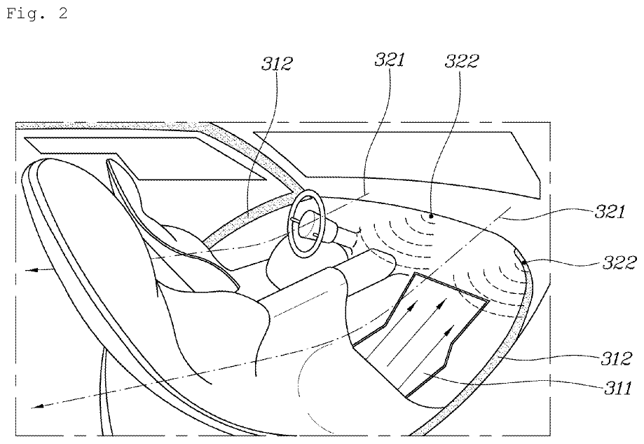

FIG. 1 is a configuration diagram of a motion sickness reduction system for vehicle occupants according to an embodiment of the present invention. FIG. 2 is a diagram illustrating the driving display of the motion sickness reduction system for vehicle occupants according to an embodiment of the present invention.

A preferred embodiment of the motion sickness reduction system for vehicle occupants according to the present invention will be described with reference to FIG. 1 and FIG. 2.

Motion sickness of an occupant occurring when a vehicle is traveling is caused by a difference between vehicle driving information recognized by the occupant and actual vehicle driving information.

The present invention may reduce motion sickness of an occupant by allowing the occupant to recognize vehicle driving information through interior parts of a vehicle.

The motion sickness reduction system for vehicle occupants according to the present invention is configured to operate for each individual occupant because a state in which motion sickness is caused and a state in which motion sickness is reduced are different for individual occupants.

An object of the motion sickness reduction system for vehicle occupants according to the present invention is to prevent an occupant from experiencing motion sickness by continuously sensing the state of the occupant.

The motion sickness reduction system for vehicle occupants according to the present invention includes the information collector 100 that collects driving information of a vehicle or state information of an occupant, the predictor 200 that predicts a motion sickness state of the occupant on the basis of the driving information or the state information collected by the information collector 100, and the driving display 300 that displays the driving information of the vehicle to the occupant such that the occupant can recognize the driving information on the basis of the predicted motion sickness state of the occupant.

The predictor 200 may predict a motion sickness state of the occupant by comparing information collected by the information collector 100 with preset indexes, and the driving display 300 may allow the occupant to recognize the driving information of the vehicle by controlling seats of the vehicle in various manners when the predictor 200 predicts a motion sickness state of the occupant, to thereby reduce motion sickness of the occupant.

The information collector 100 collects state information of the occupant through a camera provided inside the vehicle and configured to capture images of the occupant, a biometric sensor configured to sense biometric information of the occupant, or an indoor air sensor configured to sense indoor air of the vehicle.

The information collector 100 may capture an image of the occupant through the camera provided inside the vehicle to image the occupant and collect information on the age, expression, face color, face skin temperature, etc. of the occupant through the captured image.

In addition, the information collector 100 may collect information representing a body state of the occupant, such as body temperature, electrocardiogram, electroencephalogram, or perspiration through the biometric sensor for sensing biometric information of the occupant. The biometric sensor may be provided at a point where it can come into contact with the skin of the occupant to continuously collect biometric information of the occupant.

In addition, the information collector 100 may collect indoor environment information such as an indoor carbon dioxide concentration, an exhaust gas concentration, or air quality through the indoor air sensor for sensing indoor air and transmit all of the aforementioned information to the predictor 200.

Accordingly, it is possible to continuously detect the body state of the occupant to prevent motion sickness of the occupant.

The information collector 100 may be connected to a vehicle navigation system or a driving sensor that is provided on the outside of the vehicle and detects a state of the surface of a road on which the vehicle is traveling to collect driving information of the vehicle.

The information collector 100 may collect information on a road state such as a curve of a road on which the vehicle is traveling, uphill inclination or downhill inclination through the vehicle navigation system.

In addition, the information collector 100 may collect information on a state of the surface of a road on which the vehicle is traveling through a driving sensor that is provided on the outside of the vehicle and detects a state of the surface of a road on which the vehicle is traveling to detect vibration of the vehicle according to the road surface.

Accordingly, the predictor 200 can predict motion sickness of the occupant caused by driving of the vehicle in advance.

The predictor 200 may compare the driving information of the vehicle collected by the information collector 100 with preset driving indexes and compare the state information of the occupant collected by the information collector 100 with preset state indexes to predict a motion sickness state of the occupant.

The predictor 200 can predict a point at which motion sickness is caused in a driving section by comparing the driving information of the vehicle collected by the information collector 100 with preset driving information indexes of the vehicle.

In addition, the predictor 200 can predict start of motion sickness of the occupant by comparing the state information of the occupant collected by the information collector 100 with preset state indexes.

The driving display 300 may further include a tactile display that is provided in a seat of the vehicle and may cause the occupant to tactually recognize driving information of the vehicle.

The driving display 300 provided in a seat may cause the occupant to tactually recognize driving information of the vehicle when the predictor 200 predicts motion sickness of the occupant. Accordingly, the occupant can recognize the driving information of the vehicle even when he/she views other image media, and thus the motion sickness state can be alleviated.

The driving display 300 may include a visual display 310 that allows the occupant to visually recognize the driving information of the vehicle inside the vehicle.

The visual display 310 included in the driving display 300 may be provided in the interior of the vehicle and allow the occupant to visually recognize the driving information of the vehicle to reduce motion sickness of the occupant.

An occupant normally experiences motion sickness when a driving state of a vehicle does not accord with driving of the vehicle perceived by the body of the occupant, for example, when the occupant views media during driving. Otherwise, an occupant experiences motion sickness due to vibration transferred from the surface of a road on which a vehicle is traveling or the engine of the vehicle.

The visual display 310 may allow the occupant to recognize the driving information of the vehicle through interior parts of the vehicle to reduce motion sickness of the occupant due to the former reason.

The visual display 310 may allow the occupant to visually recognize the driving information of the vehicle through a display device 311 that is provided inside the vehicle and displays a speed or a driving direction of the vehicle and an ambient light 312 that represents a speed or a driving direction of the vehicle.

The display device 311 may be provided on a dashboard, a floor, or a door of the vehicle and may display a speed and a driving direction of the vehicle through various methods. FIG. 2 illustrates that the display device 311 is provided on the floor of the vehicle.

In addition, the ambient light 312 may represent driving information such as driving straight, left turn, or right turn of the vehicle with flow of light and lights in different colors on both sides using conventional ambient lights 312 provided on doors or the cockpit of the vehicle.

The driving display 300 may include a tactile display 320 that tactually notifies the occupant of a driving situation inside the vehicle.

The tactile display 320 may allow the occupant to recognize driving information of the vehicle through the skin of the occupant using tactile sensation or temperature such that the occupant can feel the driving information of the vehicle through his/her skin even in a state in which his/her sight or hearing is blocked.

The tactile display 320 may allow the occupant to tactually recognize driving information of the vehicle through an air vent 321 of the vehicle and an ultrasonic haptic interface 322 provided inside of the vehicle.

The tactile display 320 may control a blowing direction through the air vent 321 of the vehicle to allow the occupant to recognize driving information of the vehicle. When the vehicle turns left or right or is traveling on an uphill road or a downhill road, a blowing direction of the air vent 321 may be changed according thereto to allow the occupant to recognize a driving direction of the vehicle.

Further, the tactile display 320 may allow the occupant to recognize driving information of the vehicle through the ultrasonic haptic interface 322 provided in the cockpit of the vehicle. The ultrasonic haptic interface 322 generates ultrasonic waves that the occupant can feel through his/her skin toward the skin of the occupant. When the vehicle turns left or right or is traveling on an uphill road or a downhill road, an ultrasonic wave generation direction of the ultrasonic haptic interface 322 may be changed to allow the occupant to recognize driving information of the vehicle.

Accordingly, the occupant can naturally recognize driving information of the vehicle and his/her motion sickness can be reduced.

The motion sickness reduction system may further include the controller 400 that controls the indoor air of the vehicle by controlling the vehicle when the predictor 200 predicts motion sickness of a vehicle occupant.

The controller 400 controls the vehicle to change the indoor air condition of the vehicle in order to reduce motion sickness of the occupant when the predictor 200 predicts motion sickness of the occupant.

To solve a cause of motion sickness of the occupant, such as increase in carbon dioxide inside the vehicle, the controller 400 may ventilate the vehicle. Accordingly, motion sickness of the occupant can be reduced.

The controller 400 may reduce motion sickness of the occupant by operating the windows, air conditioner, air purifier, oxygen generator or aroma generator of the vehicle to control the indoor air of the vehicle.

The controller 400 may ventilate the vehicle by operating the windows of the vehicle or operating the air conditioner of the vehicle in an outdoor air circulation mode in order to reduce motion sickness of the occupant.

Further, when the controller 400 cannot operate the windows of the vehicle or perform outdoor air circulation due to weather, the controller 400 may decrease carbon dioxide concentration inside the vehicle by operating the air conditioner or oxygen generator of the vehicle to reduce motion sickness of the occupant.

Moreover, the controller 400 may reduce motion sickness of the occupant caused by bad smell generated inside the vehicle by operating the aroma generator of the vehicle.

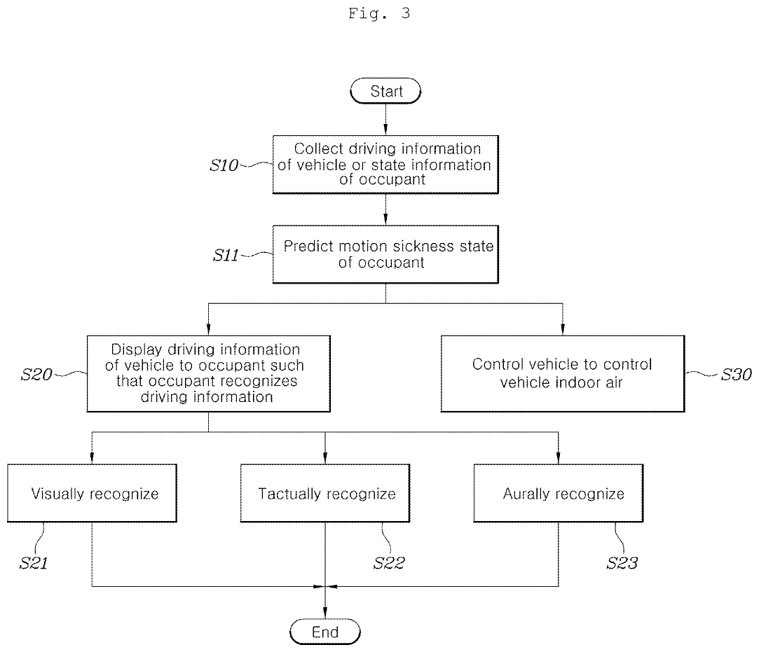

FIG. 3 is a flowchart of a motion sickness reduction method for vehicle occupants according to an embodiment of the present invention.

A preferred embodiment of the motion sickness reduction method for vehicle occupants according to the present invention will be described with reference to FIG. 3.

The motion sickness reduction method for vehicle occupants according to the present invention includes an information collection step S10 of collecting driving information of a vehicle or state information of an occupant, a prediction step S11 of predicting a motion sickness state of the occupant on the basis of the driving information or the state information collected in the information collection step S10, and a driving display step S20 of displaying driving information of the vehicle to the occupant such that the occupant can recognize the driving information on the basis of the motion sickness state of the occupant predicted in the prediction step S10.

In the information collection step S10, the state information of the occupant is collected through a camera provided inside the vehicle and configured to capture images of the occupant, a biometric sensor configured to sense biometric information of the occupant, or an indoor air sensor configured to sense indoor air.

In the information collection step S10, the driving information of the vehicle is collected through a vehicle navigation system or a driving sensor that is provided on the outside of the vehicle and is configured to detect a state of the surface of a road on which the vehicle is traveling.

In the prediction step S11, a motion sickness state of the occupant is predicted by comparing the driving information of the vehicle collected in the information collection step S10 with preset driving indexes and comparing the state information of the occupant collected in the information collection step S10 with preset state indexes.

The driving display step S20 may include a visual display step S21 of allowing the occupant to visually recognize the driving information of the vehicle inside the vehicle.

In the visual display step S21, the occupant is allowed to visually recognize the driving information of the vehicle through the display device 311 that is provided inside the vehicle and displays a speed or a driving direction of the vehicle and the ambient light 312 that is provided inside the vehicle and indicates a speed or a driving direction of the vehicle.

The driving display step S20 may include a tactile display step S22 of tactually notifying the occupant of a driving situation inside the vehicle.

In the tactile display step S22, the occupant is allowed to tactually recognize the driving information of the vehicle through the air vent 321 of the vehicle and the ultrasonic haptic interface 322 provided inside the vehicle.

The motion sickness reduction method may further include a control step S30 of controlling the vehicle to control the indoor air of the vehicle when motion sickness of the occupant is predicted in the prediction step S11.

In the control step S30, motion sickness of the occupant is reduced by operating the windows, air conditioner, air purifier, oxygen generator or aroma generator of the vehicle to control the indoor air of the vehicle.

Referring back to FIG. 1, the motion sickness reduction system for vehicle occupants according to the present invention includes an information collector 100 configured to collect driving information of a vehicle and motion sickness state information of an occupant of the vehicle, a predictor 100 configured to predict a motion sickness state of the occupant through comparison with a preset value based on the information collected by the information collector 100, and a driving display 300 configured to control a seat on which the occupant sits such that the occupant recognizes the driving information of the vehicle based on a motion sickness state of the occupant predicted by the predictor 200.

The information collector 100 may collect state information of the occupant to check motion sickness state information, detect a curved road, an uphill road, and a downhill road on a travel route of the vehicle, which may affect motion sickness of the occupant, and collect information on road surface states which may affect vehicle vibration.

The driving display 300 may further include a tactile display 320 provided in seats of the vehicle and configured to allow the occupant to tactually recognize the driving information of the vehicle.

When the predictor 200 predicts motion sickness of the occupant, the driving display 300 provided in the seats may allow the occupant to tactually recognize the driving information of the vehicle. Accordingly, the occupant can recognize the driving information of the vehicle even while viewing other image media and thus motion sickness can be reduced.

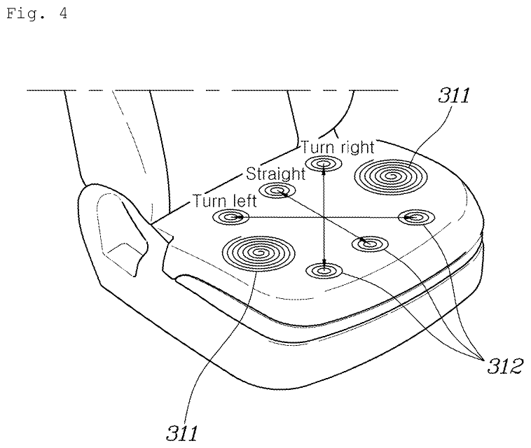

FIG. 4 is a diagram illustrating the tactile display 320 of the motion sickness reduction system for vehicle occupants according to an embodiment of the present invention.

The tactile display may allow the occupant to tactually recognize the driving information of the vehicle through cooling fans 311 and vibrating haptic interfaces 312 provided in the seats of the vehicle.

Referring to FIG. 4, the occupant may be allowed to recognize a traveling direction of the vehicle by blowing air through the cooling fans 311 provided in a seat cushion in the traveling direction as an embodiment of the tactile display 320.

Further, the tactile display 320 may allow the occupant to recognize a traveling direction by notifying the occupant of driving straight, left turn, or right turn through the vibrating haptic interfaces 212 provided in the seat cushion to reduce motion sickness of the occupant.

The driving display 300 may further include a visual display 310 provided in the seats of the vehicle and configured to allow the occupant to visually recognize the driving information of the vehicle.

When the predictor 200 predicts motion sickness of the occupant, the driving display 300 provided in the seats may allow the occupant to recognize the driving information of the vehicle. Accordingly, the occupant can intuitively recognize the driving information of the vehicle, and motion sickness can be reduced.

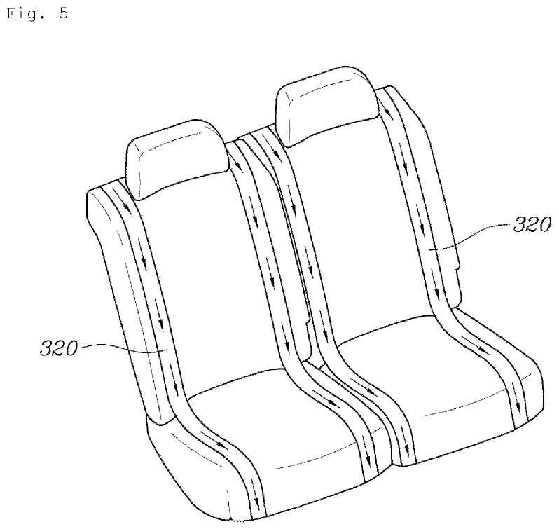

FIG. 5 is a diagram illustrating the visual display 310 of the motion sickness reduction system for vehicle occupants according to an embodiment of the present invention.

The visual display 310 may allow the occupant to recognize the driving information of the vehicle at any angle of the view of the occupant through a light provided in the seats of the vehicle.

Referring to FIG. 5, the occupant can recognize a driving situation of the vehicle through a light provided in the seats of the vehicle at any angle of the view of the occupant. The occupant can recognize a driving situation such as a traveling direction and a speed of the vehicle through the light, and motion sickness of the occupant can be reduced.

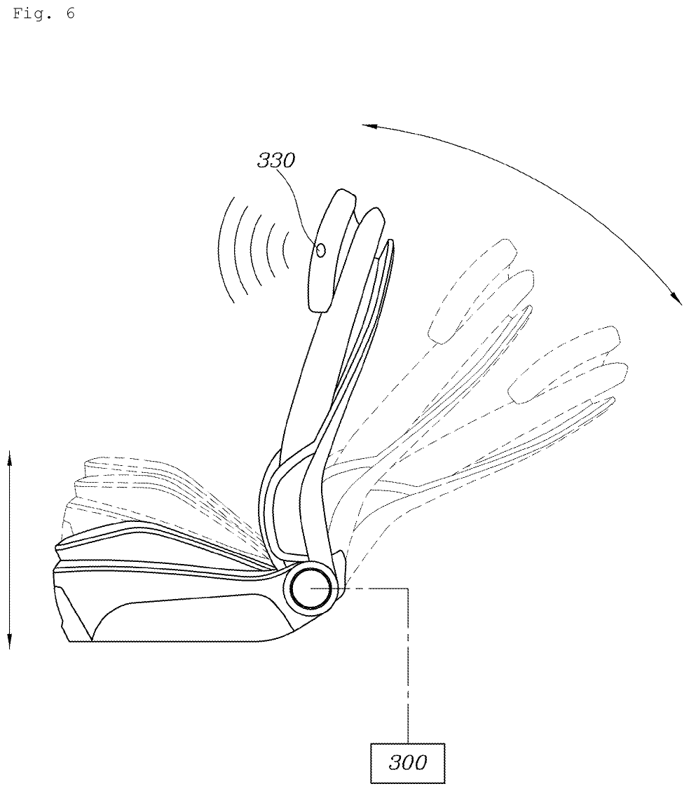

FIG. 6 is a diagram illustrating changing of sitting positions of a seat according to an auditory display 330 and the driving display 300 of the motion sickness reduction system for vehicle occupants according to an embodiment of the present invention.

The driving display 300 may further include an auditory display 330 configured to allow the occupant to aurally recognize the driving information of the vehicle through a speaker provided in the seats or provided adjacent to the seats.

Referring to FIG. 6, the auditory display 330 included in the driving display 300 may allow the occupant to aurally recognize the driving information of the vehicle through the speaker provided in the seats or provided adjacent to the seats. Accordingly, the occupant can aurally recognize the driving information of the vehicle even when the occupant closes his/her eyes or views other image media.

The driving display 300 may reduce motion sickness of the occupant by controlling air cells or a seat rotating device provided in the vehicle seats to change sitting positions of the occupant.

Referring to FIG. 6, the driving display 300 may control air cells provided in seat cushions to raise the view of the occupant such that the occupant can recognize driving information of the vehicle through a window or control the seat rotating device of the vehicle to change a sitting position of a seat to a relaxed position to induce the occupant to fall asleep, thereby reducing motion sickness.

A motion sickness reduction method for vehicle occupants according to the present invention will be described with reference to FIG. 3.

The motion sickness reduction method for vehicle occupants according to the present invention includes an information collection operation S10 of collecting driving information of a vehicle and motion sickness state information of an occupant of the vehicle, a prediction operation S11 of predicting a motion sickness state of the occupant through comparison with a preset value based on the information collected in the information collection operation S10, and a seat control operation S20 of controlling a seat on which the occupant sits such that the occupant recognizes the driving information of the vehicle based on a motion sickness state of the occupant predicted in the prediction operation S11.

In the information collection operation S10, the state information of the occupant may be collected through any one or any two or more of a camera configured to capture images of the occupant, a biometric sensor configured to sense biometric information of the occupant, and an indoor air sensor configured to sense indoor air of the vehicle.

In the information collection operation S10, the driving information may be collected through either one or both of the vehicle's navigation system and a driving sensor provided outside of the vehicle to detect a state of a road surface the vehicle is traveling on.

In the prediction operation S11, the motion sickness state may be predicted by comparing the driving information collected in the information collection operation S10 with preset driving indexes and comparing the state information of the occupant collected in the information collection operation S10 with preset state indexes.

The seat control operation S20 may further include a tactile display operation S22 of allowing the occupant to tactually recognize the driving information of the vehicle.

In the tactile display operation S22, the occupant may be allowed to tactually recognize the driving information of the vehicle through a cooling fan 311 or a vibrating haptic interface 312 provided in seats of the vehicle.

The seat control operation S30 may further include a visual display operation S21 of allowing the occupant to visually recognize the driving information of the vehicle.

In the visual display operation S21, the occupant may be allowed to visually recognize the driving information of the vehicle at any angle of the view of the occupant through a light provided in the seats of the vehicle.

The seat control operation S20 may further include an auditory display configured to allow the occupant to aurally recognize the driving information of the vehicle through a speaker provided in the seats or provided adjacent to the seats.

In the seat control operation S20, air cells or a seat rotating device provided in seat cushions of the seats of the vehicle may be controlled to change a sitting position of the occupant to reduce motion sickness of the occupant.

Although a specific embodiment of the present invention has been disclosed for illustrative purposes, those skilled in the art will appreciate that various modifications and alterations are possible, without departing from the scope and spirit of the invention as disclosed in the accompanying claims.

The motion sickness reduction system for vehicle occupants according to the present invention can collect state information of an occupant and driving information of a vehicle and predict occurrence of motion sickness of the occupant through the predictor on the basis of the state information of the occupant and the driving information of the vehicle.

Upon prediction of motion sickness of an occupant, it is possible to reduce the motion sickness of the occupant by allowing the occupant to recognize driving information of the vehicle through the visual display and the tactile display of the vehicle.

Upon prediction of motion sickness of an occupant, it is possible to reduce the motion sickness of the occupant by ventilating the vehicle through the controller of the vehicle.

In addition, it is possible to allow the occupant to recognize driving information such as a traveling direction and a speed of the vehicle by controlling a seat to reduce motion sickness of the occupant.

Furthermore, it is possible to reduce motion sickness of the occupant by controlling an indoor air control device based on motion sickness information of the occupant input in real time.

What is claimed is:

1. A motion sickness reduction system for vehicle occupants, comprising:
an information collector configured to collect driving information of a vehicle or state information of an occupant of the vehicle;
a predictor configured to predict a motion sickness state of the occupant based on the driving information or the state information; and
a driving display configured to display the driving information to the occupant for recognizing the motion sickness state.

2. The motion sickness reduction system of claim 1, wherein the information collector collects the state information through any one or any two or more of a camera configured to capture images of the occupant, a biometric sensor configured to sense biometric information of the occupant, and an indoor air sensor configured to sense indoor air of the vehicle, or the driving information through either one or both of the vehicle's navigation system and a driving sensor provided outside of the vehicle to detect a state of a road surface the vehicle is traveling on.

3. The motion sickness reduction system of claim 1, wherein the predictor predicts the motion sickness state by comparing the driving information with preset driving indexes and comparing the state information with preset state indexes.

4. The motion sickness reduction system of claim 1, wherein the driving display includes a visual display configured to indicate the driving information inside the vehicle, and
wherein the visual display allows the occupant to visually recognize the driving information through a display device, inside the vehicle, configured to display any one or any two or more of a speed of the vehicle, a driving direction of the vehicle, and an ambient light configured to indicate the speed or the driving direction of the vehicle.

5. The motion sickness reduction system of claim 1, wherein the driving display includes a tactile display configured to tactually notify the occupant of a driving situation inside the vehicle, and
wherein the tactile display allows the occupant to tactually recognize the driving information of the vehicle through an air vent of the vehicle and an ultrasonic haptic interface provided inside the vehicle.

6. The motion sickness reduction system of claim 1, further comprising a controller configured to control vehicle indoor air when the predictor predicts motion sickness of a vehicle occupant, and
wherein the controller is further configured to reduce the motion sickness by operating any one or any two or more of a window, an air conditioner, an air clear, an oxygen generator, and an aroma generator of the vehicle to control the vehicle indoor air.

7. The motion sickness reduction system of claim 1, wherein the driving display controls a seat on which the occupant is seated to display the driving information to the occupant for recognizing the motion sickness state.

8. The motion sickness reduction system of claim 7, wherein the driving display includes an auditory display configured to aurally notify the occupant of a driving situation inside the vehicle through a speaker mounted on the seat or mounted adjacent to the seat.

9. The motion sickness reduction system of claim 7, wherein the driving display controls an air cell or a seat rotation device mounted on a seat cushion of the seat to change the occupant's sitting posture to reduce motion sickness of the occupant.

10. The motion sickness reduction system of claim 7, wherein the driving display includes a visual display configured to indicate the driving information inside the vehicle, and
wherein the visual display allows the occupant to visually recognize the driving information of the vehicle from any angle of the occupant's field of view through a display device mounted on the seat.

11. A motion sickness reduction method for vehicle occupants, comprising:
an information collection operation of collecting driving information of a vehicle or state information of an occupant of the vehicle;
a prediction operation of predicting a motion sickness state of the occupant based on the driving information or the state information; and
a driving display operation of displaying the driving information to the occupant for recognizing the motion sickness state.

12. The motion sickness reduction method of claim 11, wherein, in the information collection operation, the state information is collected through any one or any two or more of a camera configured to capture images of the occupant, a biometric sensor configured to sense biometric information of the occupant, and an indoor air sensor configured to sense indoor air of the vehicle, or the driving information is collected through either one or both of the vehicle's navigation system and a driving sensor provided outside of the vehicle to detect a state of a road surface the vehicle is traveling on.

13. The motion sickness reduction method of claim 11, wherein, in the prediction operation, the motion sickness state is predicted by comparing the driving information with preset driving indexes and comparing the state information with preset state indexes.

14. The motion sickness reduction method of claim 11, wherein the driving display operation includes a visual display operation indicating the driving information inside the vehicle, and
wherein, in the visual display operation, the occupant is allowed to visually recognize the driving information of the vehicle through a display device inside the vehicle configured to display any one or any two or more of a speed of the vehicle, a driving direction of the vehicle, and an ambient light configured to indicate the speed or the driving direction of the vehicle.

15. The motion sickness reduction method of claim 11, wherein the driving display operation includes a tactile display operation of allowing the occupant to tactually recognize the driving information of the vehicle inside the vehicle, and
wherein, in the tactile display operation, the occupant is allowed to tactually recognize the driving information of the vehicle through an air vent of the vehicle and an ultrasonic haptic interface provided inside the vehicle.

16. The motion sickness reduction method of claim 11, further comprising a control operation of controlling vehicle indoor air when motion sickness of a vehicle occupant is predicted in the prediction operation, and
wherein, in the control operation, motion sickness of the occupant is reduced by operating any one or any two or more of a window, an air conditioner, an air cleaner, an oxygen generator, and an aroma generator of the vehicle to control the vehicle indoor air.

17. The motion sickness reduction method of claim 11, wherein, in the driving display operation, a seat on which the occupant is seated is controlled to display the driving information to the occupant for recognizing the motion sickness state.

18. The motion sickness reduction method of claim 17, wherein the driving display operation includes an auditory display operation of aurally notifying the occupant of a driving situation inside the vehicle through a speaker mounted on the seat or mounted adjacent to the seat.

19. The motion sickness reduction method of claim 17, wherein, in the driving display operation, an air cell or a seat rotation device mounted on a seat cushion of the seat is controlled to change the occupant's sitting posture to reduce motion sickness of the occupant.

20. The motion sickness reduction method of claim 17, wherein the driving display operation includes a visual display operation indicating the driving information inside the vehicle,
wherein, in the visual display operation, the occupant is allowed to visually recognize the driving information of the vehicle from any angle of the occupant's field of view through a display device mounted on the seat.
